(19) United States
(12) Patent Application Publication
(10) Pub. No.: US 2023/0089677 A1
(43) Pub. Date: Mar. 23, 2023

(54) High Protein Food Article

(71) Applicant: General Mills, Inc., Minneapolis, MN (US)

(72) Inventors: Aaron Rolla Amdor, Delano, MN (US); Natasha Weatherby, Minneapolis, MN (US); Dana Katharine Zychowski, Minneapolis, MN (US)

(73) Assignee: General Mills, Inc., Minneapolis, MN (US)

(21) Appl. No.: 17/910,251

(22) PCT Filed: Mar. 10, 2020
(86) PCT No.: PCT/US2020/021882

§ 371 Date: Sep. 8, 2022

(51) Int. Cl. A21D 2/26; A23P 20/20; A23P 30/10; A21D 13/064; A21D 13/14

(52) U.S. Cl. CPC A21D 2/266; A21D 13/14; A21D 13/064; A23P 20/20; A23P 30/10

(57) ABSTRACT

A high protein food article having a protein content of at least 20% by weight of the food article is provided. The high protein food article has a desirable texture that is stable over an extended shelf life. The high protein food article includes powdered protein ingredient and visible particulates that include protein crisp particulates.

### BACKGROUND

Consumers are increasingly looking for foods that meet their nutritional needs without requiring preparation. Ready-to-eat protein products meet a need for consumers. Ready-to-eat protein products are particularly challenging because high protein content can cause hardening over the shelf life and/or cause an unpleasant taste. Thus, there is a need for good-tasting ready-to-eat protein products that retain a desirable texture over shelf life.

### SUMMARY

The present disclosure relates to a high protein food article that has a desirable texture and extended shelf life.

A food article is provided herein. A food article has a total protein content of at least 20% by weight of the food article, and a moisture content of about 2.5% to about 5% by weight of the food article, where the food article can include a continuous matrix comprising a powdered protein ingredient in an amount of about 5% to about to 18% by weight of the food article, a fat in an amount of about 10% to about 23% by weight of the food article, a sugar in an amount of about 20% to about 35% by weight of the food article, and a flour in an amount of about 10% to about 30% by weight of the food article; and visible particulates dispersed throughout the continuous matrix, the particulates comprising about 15% to about 40% by weight of the food article, and including protein crisp particulates that provide at least 30% by weight of the total protein in the food article.

In some embodiments, protein crisp particulates can comprise at least 70% soy protein by dry weight of a food. In some embodiments, the protein crisp particulates can be sized such that at least 50% are retained on a Number 10 mesh sieve and no more than 5% are retained on a ¼ inch mesh sieve. In some embodiments, the protein crisp particulates can have a bulk density of about 0.25 g/cm3 to about 0.35 g/cm3.

In some embodiments, the powdered protein ingredient can comprise whey protein or soybean protein. In some embodiments, the powdered protein ingredient can comprise whey protein and soy protein at a ratio of about 70:30 to about 30:70 whey protein to soy protein.

In some embodiments, the particulates can comprise grain-based particulates.

In some embodiments, the sugar comprises a syrup and a non-liquid sugar.

In some embodiments, the flour can comprise whole grain oat flour, a whole grain wheat flour, or a nut flour.

In some embodiments, the food article can have a shortbread-like texture.

In some embodiments, the food article can have a surface with an indentation.

A food product, comprising a food article described herein is also provided. In some embodiments, a food product can include a cream layer. In some embodiments, a food product can comprise at least two of the food articles sandwiching a cream layer. In some embodiments, a food product can include a cream layer in an indentation on a surface of the food article.

A method of making a food article is also provided herein. The method can include providing a dough having a total protein content of at least 18% by weight of the dough and a moisture content of about 6% to about 12% by weight of the dough, the dough including a continuous matrix comprising a powdered protein ingredient in an amount of about 5% to about to 16% by weight of the dough, fat in an amount of about 10% to about 20% by weight of the dough, sugar in an amount of about 20% to about 35% by weight of the dough, at least a portion of the sugar being a syrup, and flour in an amount of about 10% to about 30% by weight of the dough; visible particulates dispersed throughout the continuous matrix, the particulates comprising about 15% to about 40% by weight of the dough, and including protein crisp particulates that provide at least about 30% by weight of the total protein in the dough; forming the dough to produce a dough piece; and baking the dough piece to a moisture content of about 2.5% to about 5% to form the food article.

In some embodiments, the forming step can include a rotary molding process.

In some embodiments, a method can further include making the dough by combining ingredients to form an intermediate dough that contains the fat, the sugar, and the flour, the flour and the sugar being at least partially hydrated; and combining the powdered protein ingredient and the visible particulates with the intermediate dough to form the dough.

In some embodiments of a method provided herein, the powdered protein ingredient can comprise whey protein and soy protein at a ratio of about 70:30 to about 30:70 whey protein to soy protein, and the step of combining the powdered protein ingredient with the intermediate dough includes combining the whey protein with the intermediate dough prior to combining the soy protein with the intermediate dough.

In some embodiments of a method provided herein, the visible particulates can be combined with the intermediate dough prior to combining the soy protein with the intermediate dough.

A method for making a food product is also provided herein. A method of making a food product can include combining a food article provided herein with a cream layer to form the food product. In some embodiments, the cream layer can be deposited in an indentation on the food article. In some embodiments, the cream layer can be deposited on a surface of the food article and a second food article is placed on the cream layer such that the cream layer is sandwiched between the food article and the second food article.

These and various other features and advantages will be apparent from a reading of the following detailed description.

### DETAILED DESCRIPTION

Consumers often look for convenient foods that fit a desired nutritional profile. High protein content is one such nutritional profile. However, increasing protein content in many convenient, shelf stable foods can result in textures or flavors that are off-putting, and can lead to hardening and/or drying over shelf life.

It was discovered, and is disclosed herein, that using a combination of powdered protein ingredient and protein crisp particulates resulted in the ability to make a high protein (e.g., at least 20% by weight, at least 22% by weight, from about 23% to about 30% by weight, or from about 23% to about 27% total protein content by weight) food article with a surprisingly pleasing texture resembling shortbread. A food article provided herein also has a shelf life at room temperature of at least 80 days (e.g., at least 100 days, at least 200 days, or at least 240 days) without a significantly adverse effect on texture.

A food article provided herein includes a continuous matrix that comprises a powdered protein ingredient, a fat, a sugar, and a flour. A powdered protein ingredient can be included in the continuous matrix of a food article in an amount of about 5% to about to 18% (e.g., about 5% to about 20%, or about 5% to about 18%) by weight of the food article.

As used herein, a powdered protein ingredient refers to one or more protein concentrate powder or a protein isolate powder having a protein content of at least 70% (e.g., at least 85%, at least 90%, or at least 95%) by weight of the powdered protein ingredient. Suitable powdered protein ingredients include, for example, dairy protein concentrates and/or isolates (e.g., milk protein, whey, casein, and the like), legume protein concentrates and/or isolates (e.g., soybean, lentil, pea, and the like), grain protein concentrates and/or isolates (e.g., wheat, barley, oat, and the like), seed protein concentrates and/or isolates (e.g., sunflower seed, quinoa, and the like), bacterial protein concentrates and/or isolates, algal protein concentrates and/or isolates, or any combination thereof.

In some embodiments, combinations of relatively highly soluble powdered protein ingredients (e.g., whey protein, egg protein, and the like), and relatively less soluble powdered protein ingredients (e.g., soybean, casein, and the like) can be particularly useful. Such combinations can be useful at a ratio of about 80:20 highly soluble powdered protein ingredient:less soluble powdered protein ingredient to about 20:80 highly soluble powdered protein ingredient:less soluble powdered protein ingredient (e.g., about 70:30 to about 30:70, about 60:40 to about 40:60, or about 50:50).

A fat can be included in the continuous matrix of a food article in an amount of about 10% to about 25% (e.g., about 10% to about 23%, about 13% to about 20%) by weight of the food article. Any edible fat can be used, including oils, hard fats, and shortenings, with shortening (e.g., palm shortening, vegetable shortening, and the like) being preferred. In some embodiments, a fat having a melting point between about 40° C. and about 50° C. can be used in a food article provided herein.

A sugar can be included in the continuous matrix of a food article in an amount of about 20% to about 35% (e.g., about 22% to about 32%, or about 23% to about 30%) by weight of the food article. A sugar can be any one or a combination of suitable sugars, including one or more granulated and/or powdered sugars (e.g., sucrose, fructose, brown sugar, and the like), one or more syrups (e.g., honey, tapioca syrup, molasses, corn syrup, and the like), or combinations thereof. In some embodiments, a sugar can be included in an amount of about 20% to about 35% (e.g., about 22% to about 32%, or about 23% to about 30%) by weight of a food article as a combination of a non-liquid sugar (e.g., one or more granulated and/or powdered sugar) and a syrup, where the non-liquid sugar is included in an amount of about 5% to about 25% (e.g., about 8% to about 22%, about 10% to about 20%, or about 12% to about 18%) by weight of the food article.

A flour can be included in the continuous matrix of a food article in an amount of about 10% to about 30% (e.g., about 10 to about 25%, or about 15 to about 25%) by weight of the food article. Any flour can be used, including one or more grain flour (e.g., wheat, oat, barley, and the like), one or more nut flour (e.g., peanut, almond, cashew, and the like), one or more root flour (e.g., tapioca, potato, and the like), and the like, or any combination thereof. In some embodiments, a combination of a grain flour (e.g., oat flour) and a nut flour (e.g., peanut flour) can contribute a good texture while providing additional protein. A combination of a grain flour and a nut flour can be included at a ratio of from about 15:1 to about 2:1 grain flour:nut flour (e.g., about 13:1 to about 4:1, or about 11:1 to about 5:1).

A food article provided herein includes visible particulates distributed throughout the continuous matrix. Visible particulates can be included in a food article provided herein in an amount of about 15% to about 40% (e.g., about 20% to about 35%) by weight of the food article. At least a portion of the visible particulates include protein crisp particulates. In some embodiments, protein crisp particulates can be included in an amount of about 8% to about 25% (e.g., about 10% to about 20%, or about 10% to about 15%) by weight of a food article provided herein.

Protein crisp particulates can provide at least 30% (e.g., at least 40%, or at least 50%) of the protein content in a food article provided herein. In some embodiments, protein crisp particulates can contribute protein content to a food article provided herein in an amount of at least 6% (e.g., at least 7%, at least 8%, about 9% to about 25%, or about 10% to about 20%) protein by weight of the food article.

As used herein, the term “protein crisp particulate” refers to a dry (e.g., moisture content of less than 10%, less than 8% moisture content, or less than 6% moisture content) extruded protein having at least 60% (e.g., at least 70%, at least 85%, or at least 90%) protein by weight. Protein crisp particulates can include any appropriately sized form, including nuggets, flakes, grains, and the like. Appropriately sized protein crisp particulates include particulates where at least 50% of the particulates are retained on a Number 10 mesh sieve and no more than 5% of the particulates are retained on a ¼ inch mesh sieve. In some cases, protein crisp particulates are particulates where at least 65% of the particulates are retained on No. 10 mesh sieve and no more than 5% of the particulates are retained on No. 4 mesh sieve. In some embodiments, at least 50% or at least 70% of the particulates are retained on a No. 6 mesh. While not being bound by theory, it is believed that protein crisp particulates having the described size can contribute to the desired texture and prolonged shelf life of a food product described herein because their surface area to volume provides a rate of liquid (e.g., water, syrup, or other liquid ingredient) absorption that ensures that the particulates are not too hard for consumers enjoy, while also not creating a hard or overly dry product over shelf life.

Protein crisp particulates suitable for use herein can be made from any appropriate vegetable or microbial protein source, such as legume protein (e.g., soybean protein, pea protein, and the like), grain protein (e.g., wheat protein, barley protein, oat protein, and the like), seed protein (e.g., sunflower seed protein, quinoa protein, and the like), bacterial protein, algal protein, or any combination thereof. In some embodiments, protein crisp particulates can include textured vegetable protein (TVP) particulates.

In some embodiments, protein crisp particulates suitable for use in a food product provided herein can have a bulk density of about 0.20 g/cm³ to about 0.35 g/cm³ (e.g., about 0.25-0.31 g/cm³.

In some embodiments, visible particulates can also include one or more particulates other than protein crisp particulates, including without limitation, one or more grain (e.g., oat, barley, wheat, and the like), one or more seeds (e.g., quinoa, sunflower seed, and the like), one or more nut (e.g., peanut, almond, cashew, and the like), one or more confection (e.g., candy, chocolate, and the like), or any combination thereof. In some embodiments, particulates other than protein crisp particulates can have a similar size and/or appearance as the included protein crisp particulates. In some embodiments, the protein crisp particulates can appear almost indistinguishable from other particulates, such as grain particulates (e.g., cut or rolled oats or barley flakes).

Additional ingredients can be included in a food article provided herein. For example, emulsifiers (e.g., lecithin, or the like), flavorants (e.g., spices, extracts, cocoa powder, or the like), colorants (e.g., extracts, fruit and/or vegetable juices, dyes, and the like), salts (e.g., table salt, sea salt, and the like), browning agents, and leaveners, or any combination thereof, can be included in a food article provided herein. Additional ingredients can be included in a total amount of less than 10% (e.g., less than 8%, or less than 6%).

A food article provided herein can have a moisture content of from about 2.5% to about 5% (e.g., about 3% to about 4%) by weight. A moisture content within this range contributes to an extended shelf life by reducing microbial activity within the article. In addition, a moisture content of from about 2.5% to about 5% (e.g., about 3% to about 4%) can contribute to a desirable texture of a food article provided herein.

A food article provided herein can have any appropriate form. For example, a food article provided herein can resemble a biscuit or cracker, a cookie, or a bar. A food article provided herein can be enjoyed by consumers alone, with other food compositions, such as spreads, toppings, or as a topping itself on other foods, such as ice cream, yogurt, or the like. In some embodiments, a food article provided herein can be combined with a cream layer (e.g., a spread, a frosting, or a confectionary filling) to form a food product. A particularly desirable cream layer suitable for combining with a food article provided herein is a high protein nut butter-based composition, such as described in US Provisional Patent Application No. 62/971,622 titled “High Protein Food” by Brown, et al., filed Feb. 7, 2020, which can result in a high overall protein level and provide a particularly desirable texture combination.

In some embodiments, a food article can include an indentation on a surface suitable for filling with a cream layer. In some embodiments, a food article provided herein can used along with a second food article to sandwich a cream layer between them. A food article or food product provided herein can be packaged in any suitable packaging, such as a foil or plastic wrapper.

Also provided herein are methods of making a food article provided herein. A food article provided herein can be made from a dough having a moisture content of from about 6% to about 12% (e.g., from about 8% to about 10%) by weight of the dough, which is formed to produce a dough piece, and then baked to a moisture content of about 2.5% to about 5% to form a food article described herein. A dough suitable for making a food article provided herein includes a continuous matrix comprising a powdered protein ingredient, a fat, a sugar, and a flour, and visible particulates dispersed throughout the continuous matrix, where at least a portion of the visible particulates are protein crisp particulates. A suitable dough typically contains about 5% to about 16% by weight powdered protein ingredient, about 10% to about 20% by weight fat, about 20% to about 35% by weight sugar, about 10% to about 30% by weight flour, and about 15% to about 40% by weight visible particulates. It is to be understood that the contents of the dough can be adjusted accordingly to result in a food article as described above once formed and baked.

A dough can be made using any appropriate method and equipment. Particularly useful is a method where the dough is formed by first combining fat, sugar, and flour and sugar to form an intermediate dough in which the sugar and flour are at least partially hydrated, and then combining powdered protein ingredient and visible particulates to the intermediate dough. It is to be understood that an intermediate dough can be produced in a manner that sufficiently combines the ingredients in the intermediate dough, but does not melt the fat or cause separation of the ingredients. An intermediate dough can appear glossy, smooth, and/or uniform, and can be sufficiently stable to be held at room temperature for up to 4 hours (e.g., up to 2 hours) without separation of the ingredients and without becoming too dry and/or stiff. Such a method can ensure sufficient hydration of flour and sugar before addition of a powdered protein ingredient.

A powdered protein ingredient and visible particulates can be combined with an intermediate dough using any appropriate method. It is to be understood that combining a powdered protein ingredient and visible particulates can be done in a manner that limits mechanical energy applied to the combined ingredients. Preferably, powdered protein ingredient and visible particulates are mixed sufficiently to just distribute the powdered protein ingredient and visible particulates throughout the dough. Such a method can prevent the visible particulates from being reduced significantly in size and/or cause excessive hydration of the powdered protein ingredient.

In some embodiments, whey protein and/or visible particulates can be combined with an intermediate dough prior to combining soy protein with the intermediate dough. Combining whey protein and/or visible particulates with an intermediate dough prior to combining soy protein to the intermediate dough can allow the whey protein and/or visible particulates to at least partially hydrate before combining soy protein with the intermediate dough. This can result in a dough that is not too crumbly and/or dry to readily to be readily formed into pieces. Such a method produces a dough that can conveniently be formed using a number of different methods (e.g., rolling, sheeting, cutting, rotary molding, and the like). In particular, such a method conveniently produces a dough that can be formed into pieces using a rotary molding method without excess sticking in the rotary mold or fragility of the formed pieces.

A method provided herein can optionally include combining the baked food article with one or more additional food compositions (e.g., a cream layer) to produce a food product described above. For example, a food article can have a cream layer applied to a surface (e.g., deposited in an indentation), and optionally combined with a second food article to sandwich the cream layer between the food articles.

The following examples are provided to show selected embodiments of the invention described herein. The examples are not intended to limit the invention to any particular embodiment.

### Examples

### Example 1

Several formulations of dough were produced, with varying levels of total protein, sugar content, fat content, flour content, and particulates. Formulations representing Variations 1, 2, and 3 described in Table 1 were produced in plant tests, where the doughs were produced, rotary molded into a biscuit shape, then baked to a moisture content of about 2.5% to about 5%.

Table 1

| Phase | Ingredient | Variation 1 | Variation 2 | Variation 3 |
|---|---|---|---|---|
| | Total protein (% by cooked weight) | 20-25 | 20-25 | 20-25 |
| Continuous | Powdered protein ingredient (% by cooked weight) | 20-25 | 15-20 | 7-18 |
| | Fat (% by cooked weight) | 10-15 | 10-15 | 10-20 |
| | Sugar (% by cooked weight) | 25-35 | 25-35 | 25-35 |
| | Flour (% by cooked weight) | 3-5 | 3-5 | 15-25 |
| Particulates | Total particulates (% by cooked weight) | 20-35 | 20-35 | 15-25 |
| | Protein crisp particulates (% protein contributed) | 0 | 15-20 | 30-60 |

It was observed that biscuits made according to Variation 1, which included no protein crisp particulates, were too fragile prevent breakage during forming, baking, and/or application of a cream layer. Variation 2, included about 15-20% of the total protein content as protein crisp particulates. Variation 2 formulations survived production, including forming, baking, and application of a cream layer, but were harder than desired. Formulations in Variation 3, which increased the amount of protein included as protein crisp particulates, and adjusted flour content to be slightly higher than Variations 1 and 2, produced a nice balance of processability and a desirable, shortbread-like texture. It was noted that formulations within Variation 3, which included a syrup as a portion of the sugar content had a more tender texture.

Various formulations were also produced using various mix procedures. It was observed that mix procedures that controlled the total mechanical shear applied to the protein dough and controlled the extent of protein hydration improved the ability to withstand the manufacturing process (extraction efficiency at the rotary, fragility of baked product) while maintaining desirable finished product attributes (increased softness, decreased glassy/toothpack eating experience).

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A food article having a total protein content of at least 20% by weight of the food article, and a moisture content of about 2.5% to about 5% by weight of the food article, the food article including:
a. a continuous matrix comprising a powdered protein ingredient in an amount of about 5% to about to 18% by weight of the food article, a fat in an amount of about 10% to about 23% by weight of the food article, a sugar in an amount of about 20% to about 35% by weight of the food article, and a flour in an amount of about 10% to about 30% by weight of the food article; and
b. visible particulates dispersed throughout the continuous matrix, the particulates comprising about 15% to about 40% by weight of the food article, and including protein crisp particulates that provide at least 30% by weight of the total protein in the food article.

2. The food article of claim 1, wherein the protein crisp particulates comprise at least 70% soy protein by dry weight.

3. The food article of claim 1, wherein the protein crisp particulates are sized such that at least 50% are retained on a Number 10 mesh sieve and no more than 5% are retained on a ¼ inch mesh sieve.

4. The food article of claim 1, wherein the protein crisp particulates have a bulk density of about 0.25 g/cm³ to about 0.35 g/cm³.

5. The food article of claim 1, wherein the powdered protein ingredient comprises whey protein or soybean protein.

6. The food article of claim 1, wherein the powdered protein ingredient comprises whey protein and soy protein at a ratio of about 70:30 to about 30:70 whey protein to soy protein.

7. The food article of claim 1, wherein the particulates comprise grain-based particulates.

8. The food article of claim 1, wherein the sugar comprises a syrup and a non-liquid sugar.

9. The food article of claim 1, wherein the flour comprises whole grain oat flour, a whole grain wheat flour, or a nut flour.

10. The food article of claim 1, wherein the food article has a shortbread-like texture.

11. The food article of claim 1, wherein the food article has a surface with an indentation.

12. A food product, comprising the food article of of claim 1 and a cream layer.

13. The food product of claim 12, wherein the food product comprises at least two of the food articles sandwiching the cream layer.

14. The food product of claim 12, wherein the cream layer is in an indentation on a surface of the food article.

15. A method of making a food article, the method comprising:
a. providing a dough having a total protein content of at least 18% by weight of the dough and a moisture content of about 6% to about 12% by weight of the dough, the dough including:
i. a continuous matrix comprising a powdered protein ingredient in an amount of about 5% to about to 16% by weight of the dough, fat in an amount of about 10% to about 20% by weight of the dough, sugar in an amount of about 20% to about 35% by weight of the dough, at least a portion of the sugar being a syrup, and flour in an amount of about 10% to about 30% by weight of the dough;
ii. visible particulates dispersed throughout the continuous matrix, the particulates comprising about 15% to about 40% by weight of the dough, and including protein crisp particulates that provide at least about 30% by weight of the total protein in the dough;
b. forming the dough to produce a dough piece; and
c. baking the dough piece to a moisture content of about 2.5% to about 5% to form the food article.

16. The method of claim 15, wherein the forming step includes a rotary molding process.

17. The method of claim 15, further comprising making the dough by:
a. combining ingredients to form an intermediate dough that contains the fat, the sugar, and the flour, the flour and the sugar being at least partially hydrated;
b. combining the powdered protein ingredient and the visible particulates with the intermediate dough to form the dough.

18. The method of claim 17, wherein the powdered protein ingredient comprises whey protein and soy protein at a ratio of about 70:30 to about 30:70 whey protein to soy protein, and the step of combining the powdered protein ingredient with the intermediate dough includes combining the whey protein with the intermediate dough prior to combining the soy protein with the intermediate dough.

19. The method of claim 18, wherein the visible particulates are combined with the intermediate dough prior to combining the soy protein with the intermediate dough.

20. The method of claim 15, wherein the food article is combined with a cream layer to form a food product.

21. The method of claim 20, wherein the cream layer is deposited in an indentation on the food article.

22. The method of claim 20, wherein the cream layer is deposited on a surface of the food article and a second food article is placed on the cream layer such that the cream layer is sandwiched between the food article and the second food article.
